(19) United States
(12) Patent Application Publication
(10) Pub. No.: US 2006/0235634 A1
(43) Pub. Date: Oct. 19, 2006

(54) Method for operating a measuring instrument

(76) Inventor: Wilhelm Florin, Duisburg (DE)

Correspondence Address: CESARI AND MCKENNA, LLP, 88 BLACK FALCON AVENUE, BOSTON, MA, 02210, US

(21) Appl. No.: 11/406,008

(22) Filed: Apr. 18, 2006

(30) Foreign Application Priority Data
Apr. 19, 2005 (DE) 10 2005 018 179.1

(51) Int. Cl. G06F 19/00

(52) U.S. Cl. 702/75

(57) ABSTRACT

A method for operating a measuring instrument whose measuring operation is clocked at a measuring frequency. The measured data acquired in the measuring operation are subjected to a frequency analysis and the measuring frequency is automatically controlled as a function of the frequency spectrum thus acquired. In this fashion a good signal-to-noise ratio is obtained.

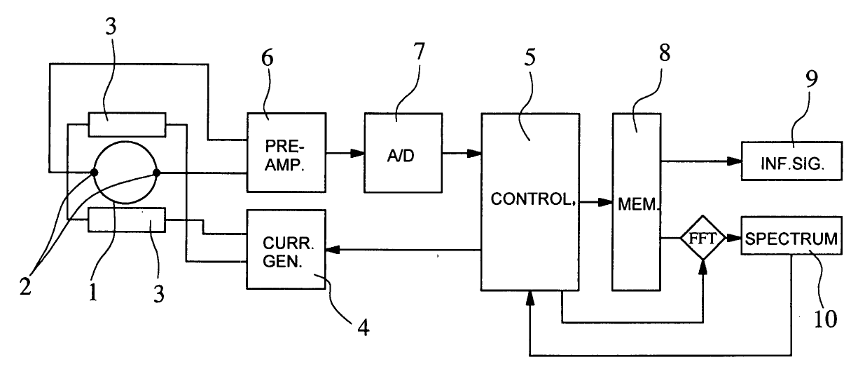

This invention relates to a method for operating a measuring instrument whose measuring operation is clocked at a measuring frequency.

### BACKGROUND OF THE INVENTION

One example employing such a method is the measuring operation of a magnetoinductive flowmeter. A magnetoinductive flowmeter is used for measuring the throughput rate of a medium as it flows through a measuring tube, for which, by means of at least one field coil, a magnetic field is generated with a magnetic-field component that extends in a direction perpendicular to the longitudinal axis of the measuring tube, and the voltage induced in the medium is collected via two measuring electrodes. The underlying concept of a magnetoinductive flowmeter goes all the way back to Faraday who in 1832 proposed employing the principle of electrodynamic induction for flow velocity measurements. According to Faraday's law of induction, a flowing medium that contains charge carriers and travels through a magnetic field will produce an electric field intensity perpendicular to the direction of flow and perpendicular to the magnetic field. A magnetoinductive flowmeter utilizes Faraday's law of induction in that by means of a field coil a magnetic field is generated with a magnetic-field component that extends in a direction perpendicular to the direction of flow. Within the magnetic field, each volume element of the flowing medium, containing a certain number of charge carriers, contributes the field intensity created in that volume element to the measuring voltage that can be collected via the measuring electrodes.

In conventional magnetoinductive flowmeters, the measuring electrodes are designed for either conductive or capacitive coupling with the flowing medium. One salient characteristic of magnetoinductive flowmeters is the proportionality between the measured voltage and the velocity of the flowing medium averaged over the cross section of the measuring tube, i.e. between the measured voltage and the volume flow.

The measured voltage that can be collected at the measuring electrodes as a function of the flow rate is typically in the range between a few microvolts and a few millivolts. That measured voltage, however, is often superposed by interfering noise voltages. These noise voltages usually appear at different frequencies as related to the frequency of the flowmeter power supply and the stroke rate of pumps. Depending on the impedance of the input circuit, the amplitude of the noise voltage can be as high as several 100 mV.

### SUMMARY OF THE INVENTION

It is therefore the objective of this invention to introduce a method for operating a measuring instrument, in particular a magnetoinductive flowmeter, whereby a good signal-to-noise ratio is obtained.

Referring to the method mentioned at the outset, the stated objective is achieved by subjecting the measured variables collected during the measuring operation to a frequency analysis and by automatically controlling the measuring frequency as a function of the frequency spectrum thereby defined.

Thus, according to the invention, the measuring frequency that clocks the measuring operation is not preset but is controlled as a function of the noise frequencies detected. There are various ways in which the measuring frequency can be controlled:

Basically, as implemented in a preferred embodiment of the invention, the measuring frequency is controlled in a manner as to derive a measuring signal with the best attainable signal-to-noise ratio. This means that the measuring frequency is continuously controlled in response to the noise amplitude distribution i.e. interference spectrum, in such fashion that it always delivers a measuring signal with the best possible signal-to-noise ratio. The significant aspect here is that during the operation of the measuring instrument, there is an immediate response to changes in the interference spectrum in that, as one interference frequency drops out, the control of the measuring frequency is automatically and immediately shifted to the new interference spectrum, possibly allowing the measuring frequency to be set at other values that would lead to an even better signal-to-noise ratio.

The interference spectrum will generally include several main frequencies that clearly stand out from the noise level. Therefore, in a preferred embodiment of the invention, the measuring frequency is automatically controlled by at least one main frequency of the acquired spectrum. This can be accomplished in different ways. Specifically, in a preferred implementation of the invention, the measuring frequency is automatically controlled by one such acquired main frequency, by a multiple integer of one such main frequency or by an integral fraction of one such main frequency.

As an alternative, one preferred embodiment of the invention provides for the measuring frequency to be automatically controlled by a frequency other than the acquired main frequency. In another preferred version of the invention, a predefined frequency range may be selected for the measuring frequency, in which case the measuring frequency will be controlled automatically within that predefined frequency range, with maximal inter-frequency separation, by several of the acquired main frequencies.

In essence, it is possible to perform the frequency analysis without regard for the phases of the captured oscillations. In a preferred embodiment of the invention, however, the frequency analysis is phase-sensitive. In this connection, a preferred version of the invention additionally controls the clocking of the measuring operation in phase-dependent fashion, preferably phase-locked with the phase of a captured oscillation whose frequency is used for controlling the measuring frequency as described above.

As stated, the method according to this invention lends itself particularly well to the operation of a magnetoinductive flowmeter. Accordingly, one preferred embodiment of the invention is aimed at a measuring instrument in the form of a magnetoinductive flowmeter that comprises a field coil and a measuring tube with two measuring electrodes, in which case, the field coil, clocked at the measuring frequency, is fed a coil-driving current, a voltage is picked off the two measuring electrodes, the voltage thus collected is subjected to a frequency analysis and the measuring frequency impinging on the field coil with a coil-driving current is controlled as a function of the acquired frequency spectrum. Specifically, in a preferred embodiment of the invention, the field coil is fed a varying constant current.

There are numerous ways in which the inventive method can be implemented and enhanced. In this context, attention is invited to the dependent claims and to the following detailed description of a preferred embodiment of the invention, with reference to the attached drawing.

### BRIEF DESCRIPTION OF THE DRAWING

In the drawing, sole FIGURE is a block diagram of a magnetoinductive flowmeter that is operated as according to my method.

### DESCRIPTION OF THE PREFERRED EMBODIMENT

The magnetoinductive flowmeter illustrated in the figure comprises a measuring tube 1 with two measuring electrodes 2 at which a voltage, induced in a medium flowing through the measuring tube 1, can be collected. The necessary magnetic field is generated by two field coils 3.

A field current generator 4 delivers a coil-driving current to the field coils 3. A microcontroller 5 activates the field current generator 4 in a manner whereby, the field coils 3, clocked at a preselected measuring frequency, are fed a varying constant current, meaning a current which is constant for a period of time and then changes to another constant value. That measuring frequency at which the measuring operation of the magnetoinductive flowmeter is clocked, is selected as will now be described:

The voltage induced in the flowing medium by the magnetic field is collected at the measuring electrodes 2 and fed to a preamplifier 6 and from there to an analog-to-digital converter 7. In addition to the voltage induced in the medium, however, noise voltages as well are coupled in and, in the same way as the induced voltage, are fed via a preamplifier 6 and an analog-to-digital converter 7 to the microcontroller 5. The values thus obtained are stored in a memory module 8 that is connected to the microcontroller 5, allowing the measured data acquired in the measuring operation to be subjected, under the control of the microcontroller 5, to a frequency analysis which in this case is a Fast Fourier Transform (FFT). The result is a frequency spectrum composed of the effective information signal 9, delivered via separate output, and the interference spectrum 10.

The interference spectrum 10 is again made available to the microcontroller 5, enabling it to control the measuring frequency. In the preferred embodiment of the invention described above, provisions are made for the measuring frequency to be automatically controlled at one of the main frequencies in the interference spectrum, preferably the predominant interference frequency. Also in this case, the frequency analysis is performed in phase-sensitive fashion to permit phase-dependent clocking of the measuring operation, specifically phase-locked with the phase of the oscillation providing the main frequency by way of which the measuring frequency is controlled.

The result is a magnetoinductive flowmeter that offers a very good signal-to-noise ratio without the occurrence of significant interference by parasitic noise voltages.

1. A method for operating a measuring instrument whose measuring operation is clocked at a measuring frequency, wherein the measured data acquired in the measuring operation are subjected to a frequency analysis, and the measuring frequency is automatically controlled as a function of the frequency spectrum defined by the frequency analysis.

2. The method as in claim 1, wherein the measuring frequency is automatically selected in a manner whereby a measuring signal with the best attainable signal-to-noise ratio is obtained.

3. The method as in claim 1, wherein the measuring frequency is controlled as a function of at least one main frequency out of the defined frequency spectrum.

4. The method as in claim 3, wherein the measuring frequency is automatically controlled at said at least one main frequency, a multiple integer of said at least one main frequency or an integral fraction of said at least one main frequency.

5. The method as in claim 3, wherein the measuring frequency is automatically controlled at a frequency other than said at least one main frequency.

6. The method as in claim 3, wherein a predefined frequency range is allocated to the measuring frequency and within said predefined frequency range, the measuring frequency is automatically controlled, with a maximum overall frequency separation, by several acquired main frequencies.

7. The method as in one of the claims 1 to 6, wherein the frequency analysis is performed in phase-sensitive fashion.

8. The method as in claim 7, wherein the clocking of the measuring operation is controlled in phase-dependent fashion, preferably phase-locked with a particular phase.

9. The method as in one of claims 1 to 6, wherein the said measuring instrument is a magnetoinductive flowmeter comprising a field coil and a measuring tube with two measuring electrodes, clocked at the measuring frequency, the field coil is fed a coil-driving current, a voltage is collected at the two measuring electrodes, the collected voltage is subjected to a frequency analysis and the measuring frequency at which the coil-driving current is fed to the field coil is controlled as a function of said defined frequency spectrum.

10. The method as in claim 9, wherein the field coil is fed a varying constant current.
